(19) United States
(12) Patent Application Publication
(10) Pub. No.: US 2008/0133736 A1
(43) Pub. Date: Jun. 5, 2008

(54) SYSTEM, METHOD, AND COMPUTER PROGRAM PRODUCT FOR TRACKING DIGITAL MEDIA IN COLLABORATIVE ENVIRONMENTS

(75) Inventors: Paul Wensley, Mill Valley, CA (US); Jon M. Bloodworth, Santa Fe, NM (US); Robert M. Goldstein, Los Angeles, CA (US)

Correspondence Address: PATENT LAW OFFICES OF MICHAEL E. WOODS, 19 Vista Marin Drive, San Rafael, CA, 94903-5205, US

(73) Assignee: AVA Mobile, Inc., Santa Fe, NM (US)

(21) Appl. No.: 11/564,842

(22) Filed: Nov. 30, 2006

(51) Int. Cl. G06F 15/173

(52) U.S. Cl. 709/224

(57) ABSTRACT

A system, method, computer program product, and propagated signal for a real-time concurrent multi-user multi-way collaboration system that is able to incorporate one or more electronic devices including one or more portable devices that permits distributed users to easily and efficiently share both content and editorial input on such content (of course, text messaging is not limited to editorial input on the content), while enabling tracking/monitoring of the resource and its uses. Specifically, the system includes an electronic resource having an associated identifier; a plurality of communication clients, inter-communicated by a network, for initiating a transfer of said electronic resource from one of said plurality of communication clients to one or more other ones of said plurality of communication clients; and an asset tracker, coupled to said network, for communicating with a data file to link said associated identifier with each communication client receiving said electronic resource.

### CROSS REFERENCE TO RELATED APPLICATIONS

This application is related to co-pending U.S. patent application Ser. No. 11/164,645 filed 30 Nov. 2006 entitled “SYSTEM, METHOD, AND COMPUTER PROGRAM PRODUCT FOR CONCURRENT COLLABORATION OF MEDIA,” Ser. No. 11/309,529 filed 18 Aug. 2006 entitled “SYSTEM, METHOD, AND COMPUTER PROGRAM PRODUCT FOR CONCURRENT COLLABORATION OF MEDIA,” and U.S. patent application Ser. No. ______ (Attorney Docket 20043-7006) filed concurrently entitled “SYSTEM, METHOD, AND COMPUTER PROGRAM PRODUCT FOR MANAGING RIGHTS OF DIGITAL MEDIA IN COLLABORATIVE ENVIRONMENTS,” all hereby expressly incorporated in their entireties by reference for all purposes.

### BACKGROUND OF THE INVENTION

The present invention relates generally to real-time collaboration systems, and more particularly to a concurrent multi-user multi-way collaboration system capable of tracking transfer or exchange among one or more client systems and methods.

The development of digital computer networks have allowed the high-speed delivery of media files, including images, video and audio, to personal computers and mobile devices. Traditionally, access to these networks has been through a “web browser”, such as Microsoft Internet Explorer and the like employing hypertext markup language (HTML) protocols.

Applications that use a web browser to display and manipulate media files are limited to the capabilities of the web browser. Most browser-based solutions provide limited built-in user interface solutions such as grid structures that force information into linear displays. The structure of web browsers does not allow for interactive two-way communication between users or multi-directional communication among multiple users. Some existing solutions use “plug-ins” or “applets” to extend the functionality of the browser to attempt some limited type of bi-directional communication. However, these solutions are limited to a “presenter” and a set of clients which become the audience. There are no solutions for true real-time multi-directional communication.

Some extensions to the web browser paradigm, such as implemented in a WebEx online meeting solution available from WebEx Communications, Inc., 3979 Freedom Circle, Santa Clara, Calif. 95054 (www.webex.com) provide a limited solution. These solutions try to implement “collaboration” or “sharing” of a desktop in an attempt to capture some of the benefits of true multi-way multi-device concurrent sharing of digital resources. However, these implementations are limited, in that they require one user (or in some newer implementations multiple users may on a non-concurrent basis) to be the “presenter” and the others to be the “audience” so they only truly capture one type of online meeting, namely the presentation. These solutions do not have a true collaborative paradigm, where each user may have the same status for moving, marking, and commenting on the media, or otherwise interacting with it (viewing and or playing for example). These implementations can be called “screen scraping” as they just send the display data, without any understanding of the media that is being displayed (including in the new Webex implementation noted above). Moreover, they are not designed to work on portable electronic devices.

A well-known, but very limited in terms of features and user options, media sharing/collaboration solution is the sharing, choosing, and selecting of media files by sending emails with digital media attachments. The user loses control over the media, as real (i.e., full) copies are sent to the other users, who then have full control over them. Some attempts to control this, via watermarking images, or sending just “down sampled” or proxy versions, corrupt the files and do not allow for full examination of the full data. Additional drawbacks include a recognition that media files may be very large, and many email solutions are incapable of exchanging large files (e.g., incapable in the sense that the system administrators/developers may impose size and/or content and/or file type restrictions). Also, the solutions are not in “real-time” and there is little in the way of feedback from one participant that the others are active in the “collaboration.”

Further, it is a problem among conventional messaging systems that two or more users are unable to unambiguously collaborate in the rendering of a media resource, such that any user at any time may set a rendering of the media resource to a desired reference on all participating clients.

Digital rights management addresses an existing solution to a perceived problem of exchanging copyrighted or other rights-restricted digital data by, among, between, and across systems. Digital Rights Management (generally abbreviated to DRM) is any of several technologies used by publishers (or copyright owners) to control access to and usage of digital data (such as software, music, movies) and hardware, handling usage restrictions associated with a specific instance of a digital work. The term often is confused with copy protection and technical protection measures (TPM). These two terms refer to technologies that control or restrict the use and access of digital media content on electronic devices with such technologies installed, acting as components of a DRM design.

Digital Rights Management is a controversial topic. Advocates argue DRM is necessary for copyright holders to prevent unauthorized duplication of their work to ensure continued revenue streams. Some critics of the technology, including the Free Software Foundation, suggest that the use of the word “Rights” is misleading and suggest that people instead use the term Digital Restrictions Management. The position put forth is that copyright holders are attempting to restrict use of copyrighted material in ways already granted by statutory or common law applying to copyright.

DRM is typically a distribution and use control system, sometimes having rudimentary asset tracking attendant to distribution control, cooperating with features built into (or added onto) various operating systems, distribution mechanisms, and “playing” applications.

Examples of DRM in portable electronic devices include iPod and the iTunes distribution system available from Apple Computers. iTunes includes a desktop component that serves as a vehicle for identifying desired copyrighted content and then receiving encrypted digital files (audio or video) for that content. The content may only be played from the iTunes application or a user may transfer a copy of this protected content to the iPod. This content may not be transferred out of this system, and content is not available to be retrieved from the iPod. Thus sharing or collaboration is limited to multiple users listening/watching the content as it is played from the iTunes or the iPod.

Microsoft Corporation has announced a portable music player (the “Zune”) that assertedly includes an ability for a user to wirelessly transfer content directly to another Zune user. The recipient is slated to have limited abilities to use the content (e.g., play the content no more than three times within a limited period (e.g., three days).

Also relevant to the present invention is the current interest in targeted advertising. Advertisers continue to search for new ways to focus their content and improve return for each advertising dollar spent. This is true across different media, print, television, radio, and the Internet. Interactivity is a word used frequently in the context of advertising and the distribution medium of a particular advertisement. To date, one of the most successful interactive advertising systems are pay-per-click in which advertisers pay whenever a user selects an advertisement presented in a web browser. Advertisers try to target users based upon keywords correlation, and receive “interaction” through “clicks” on the advertisement.

While successful, this paradigm has limitations that relate to the use of keywords for correlation and to the limitations of the web browser as an interactive client.

What is needed is a real-time concurrent multi-user multi-way collaboration system capable of operation incorporating one or more electronic devices preferably including one or more portable devices to permit distributed users to easily and efficiently share, in real time, both content and unambiguous editorial input on such content. Further, what is needed is a system to track metadata relating to an online digital asset that captures each user's or group's interest in the asset and thus, in the aggregate, defines a collective interest in the asset and self-selects a relevant market based upon the nature of the asset, the distribution, and the collective group.

### BRIEF SUMMARY OF THE INVENTION

Disclosed is a system, method, computer program product, and propagated signal for a real-time concurrent multi-user multi-way collaboration system that is able to incorporate one or more electronic devices including one or more portable devices that permits distributed users to easily and efficiently share both content and editorial input on such content (of course, text messaging is not limited to editorial input on the content). Specifically, a real-time concurrent multi-user multi-way collaboration system, method, and computer program capable of operation providing two or more users to be able to unambiguously collaborate in the rendering of a media resource, such that any user at any time may set a rendering of the media resource to a desired reference on all participating clients. The system for transmitting a media resource and one or more collaboration messages over a communications network includes a plurality of real-time messaging clients coupled to the communications network, with each client of the plurality of clients including: a communications system for receiving the media resource and for receiving the one or more collaboration messages; and a renderizer system for producing a rendering of the media resource in substantial synchronization with other ones of the real-time messaging clients; wherein a particular one of the one or more collaboration messages are transmitted by one of the messaging clients, the one or more collaboration messages including a desired reference of the rendering and each other of the messaging clients substantially synchronizing the rendering of the media resource at the desired reference using the particular one collaboration message.

The system, method, computer program product, and propagated signal of this collaborative system is adapted to track metadata relating to an online digital asset that captures each user's or group's interest in the asset and thus, in the aggregate, defines a collective interest in the asset and self-selects a relevant market based upon the nature of the asset, the distribution, and the collective group. The system includes an electronic resource having an associated identifier; a plurality of communication clients, inter-communicated by a network, for initiating a transfer of said electronic resource from one of said plurality of communication clients to one or more other ones of said plurality of communication clients; and an asset tracker, coupled to said network, for communicating with a data file to link said associated identifier with each communication client receiving said electronic resource.

The AVA media asset tracker tracks media content files from the moment they enter the AVA system and for so long as they remain within the AVA system. Reporting capabilities of the media asset tracker include how many users have shared or exchanged a particular media file with other AVA users, how many users received and viewed or played the media file, the frequency of viewing or playing the media file, and the communication “trail” of the media file, including associations among users and with other media files.

The preferred embodiments of the present invention create a more natural “processing environment” for those that work or play with digital media files, particularly when sharing/exchanging media content with others in any context. One applicable paradigm, provided to facilitate understanding, is the real-world experience of working on the same tabletop with the other users, interacting, commenting and choosing media. Moreover, our invention keeps the media files secure, by controlling the access and ability to save them. It is recognized that a modern workgroup cannot easily be at the same “tabletop” as all of the others, and that having the tools available on mobile devices is important for true interactivity.

### BRIEF DESCRIPTION OF THE DRAWINGS

FIG. 1 is a computer system that may function as a basic computer in implementing the present invention;

FIG. 2 is a generalized diagram of a portion of a network system (e.g., the Web or the Internet) to which a computer controlled display terminal used for transmitting or receiving messages is connected;

FIG. 3 is a generalized schematic of an AVA collaboration system shown in FIG. 2;

FIG. 4 is a generalized block diagram of a generic computer of the system shown in FIG. 3;

FIG. 5 is a functional block diagram of the AVA server shown in FIG. 2;

FIG. 6 is a functional block diagram of the AVA client shown in FIG. 2;

FIG. 7 is a close-up of an AVA client supporting local AVASpace;

FIG. 8 is a schematic block diagram of a preferred embodiment for an AVA real-time collaboration system including a plurality of portable electronic devices each supporting an AVA client wirelessly communicating with an AVA server through a wireless-supported communications network;

FIG. 9 is a preferred embodiment for an AVASpace recreation process implemented by a system (e.g., the system shown in FIG. 8); and

FIG. 10 is a block diagram of an asset tracking system.

### DETAILED DESCRIPTION OF THE INVENTION

The present invention relates to a real-time concurrent multi-user multi-way collaboration system capable of operation incorporating one or more electronic network devices preferably including devices having wireless network connectivity to permit distributed users to easily and efficiently share both content and editorial input on such content. Specifically, a real-time concurrent multi-user multi-way collaboration system, method, and computer program capable of operation providing two or more users to be able to unambiguously collaborate in the rendering of a media resource, such that any user at any time may set a rendering of the media resource to a desired reference on all participating clients. Further, the system tracks metadata relating to an online digital asset that captures each user's or group's interest in the asset and thus, in the aggregate, defines a collective interest in the asset and self-selects a relevant market based upon the nature of the asset, the distribution, and the collective group. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

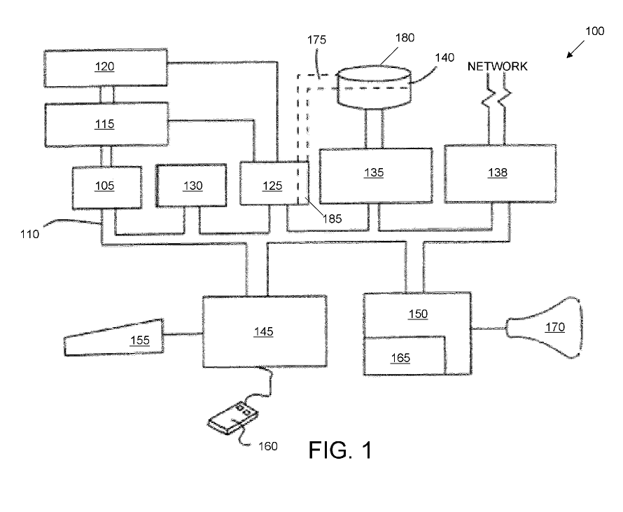

FIG. 1 is a computer system 100 that may function as a basic computer in implementing the present invention. Computer system 100 includes a central processing unit (CPU) 105, such as one of the PDA (personal digital assistant) microprocessors, PC microprocessors or workstations, e.g. Intel™ PXA270 312 MHz processor used in a Treo™ 650 portable electronic device or other microprocessor or microcontroller or controller, is provided and interconnected to various other components by a system bus 110. An operating system 115 runs on CPU 105, provides control and is used to coordinate the function of the various components of FIG. 1. Operating system 115 may be one of the commercially available operating systems such as the Palm OS available from PalmSource, Inc.; Microsoft's Windows, as well as UNIX and AIX operating systems, and the like. One or more application programs 120, controlled by the system, are moved into and out of a main memory RAM 125. These programs include the program of the present invention to be subsequently described in combination with local or wide-area network systems, such as for example, the Internet. A read only memory (ROM) 130 is connected to CPU 105 via bus 110 and includes the Basic Input/Output System (BIOS) that controls the basic computer functions. RAM 125, an I/O adapter 135 and a communications adapter 138 are also interconnected to system bus 110. I/O adapter 135 may be a Small Computer System Interface (SCSI) adapter that communicates with a disk storage device 140. Communications adapter 135 interconnects bus 110 with an outside network enabling the data processing system to communicate with other such systems over a Local Area Network (LAN) or Wide Area Network (WAN), which includes, of course, the Internet, the WEB, intranets, extranets, and other public and private networks. The terms associated with the network are meant to be generally interchangeable and are so used in the present description of the distribution network. I/O devices are also connected to system bus 110 via a user interface adapter 145 and a display adapter 150. A keyboard 155 and a pointing device (e.g., mouse 160 or a joystick, remote keypad, game controller, stylus, button navigations system, or the like) are all interconnected to bus 110 through user interface adapter 145. Display adapter 150 includes a frame buffer 165, which is a storage device that holds a representation of each pixel on a monitor or display screen 170. Images may be stored in frame buffer 165 for display on monitor 170 through various components, such as a digital to analog converter (not shown) and the like. By using the aforementioned I/O devices, a user is capable of inputting information to the system through the keyboard 155 (or other input device) or mouse 160 (or other pointing system) and receiving output information from the system via display 170. The system also contains a memory cache 175 which is illustrated as a dashed line outline and includes a portion 180 of a disk storage drive 140 and a portion 185 of RAM 125.

As noted above, preferred embodiments of the present invention may use a wide range of computing systems. One particular embodiment is most preferred, namely a use of one or more wireless-network-connected electronic devices (e.g., portable or mobile computing system) in communication with a server application and optionally one or more desktop/workstation personal computers. Client applications are supported by the electronic device and communicate via a wireless network connection, as described in more detail herein. An example of a suitable portable electronic device is represented by a Treo 650 smartphone available from Palm, Inc. (http://www.palm.com) and other similar devices. While the present invention contemplates use of virtually any suitable network-compatible computing system having a display of reasonable resolution and color depth (preferably color) such as, to simplify the discussion the computing system described in the preferred embodiments will be the Treo 650-type device. When a quality of the screen is poor (e.g., a relatively few number of colors or limited resolution) or when a bandwidth of the network communications is limited, the quality of the experience is also more limited than would be the case with improved display and/or bandwidth. In some embodiments and implementations, client applications, or server functions when present, may convert content from one system to another in an appropriate form/format.

The Treo™ 650 smartphone from Palm, Inc. combines a compact wireless mobile phone with email, organizer features, messaging, and web access. Also included is Bluetooth® technology so a user may connect wirelessly to other Bluetooth devices. Additional features include an MP3 player, a digital camera that captures video, and a color screen that is responsive to a stylus for controlling the system (alternatively a keypad may also be used for a system interface)—all in a device that is still small enough to fit in a pocket of the user. In some implementations, a “smartphone” implementation is not necessary by adapting the user interface elements consistent with the input and display features of the portable electronic device.

Additionally to simplify the following discussion, it is noted that the present invention contemplates use on many different communications networks, both public and private. In some implementations, multiple different types of network systems may be used together, and the server may, for example, bridge different communications networks and translate/convert between different protocols/formats to exchange messages between the devices and to exchange communications with any device. In the following example, use of the Internet accessed through wireless access points using is described as the preferred embodiment though other configurations are within the scope of the present invention.

Before going further into details of specific embodiments, set forth below is a general perspective of the various elements and methods that may be related to the present invention. Since a major aspect of the present invention is directed to network communications, preferably Internet communications using Internet and/or Web protocols, and use of data messaging similar to access of Web pages, an understanding of such networks and their operating principles may be helpful. The following does not go into great detail in describing the networks to which the present invention is applicable. For details on Web nodes, objects and links, reference is made to the text, Mastering the Internet, G. H. Cady et al., published by Sybex Inc., Alameda, Calif., 1996; or the text, Internet: The Complete Reference, Millennium Edition, Margaret Young et al., Osborne/McGraw-Hill, Berkeley, Calif., 1999. Any data communication system that interconnects or links computer controlled systems with various sites defines a communications network. Of course, the Internet or Web is a global network of a heterogeneous mix of computer technologies and operating systems. Higher level objects are linked to the lower level objects in the hierarchy through a variety of network server computers.

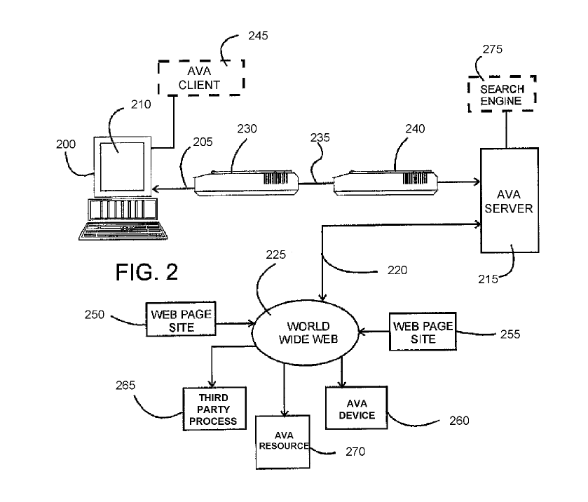

FIG. 2 is a generalized diagram of a portion of a network system (e.g., the Web or the Internet) to which a computer controlled display terminal 200 used for transmitting or receiving messages is connected. Computer display terminal 200 may be implemented by computer system 100 shown in FIG. 1 with a connection 205 (FIG. 2) equivalent to the network connection shown in FIG. 1. For purposes of the present embodiment, computer 200 serves as a client station and has received and displayed a local AVASpace 210. Reference may be made to the above-mentioned Mastering the Internet, pp. 136-147, for typical connections between local stations to the Web via network servers, any of which may be used to implement the system on which this invention is used. The system embodiment of FIG. 2 has a host dial-up connection. Such host dial-up connections have been in use for over 30 years through network access servers 215 that are linked 220 to a network 225 (e.g., the Web). Servers 215 may be maintained by a service provider to the client's display terminal 200. Server 215 is accessed by client terminal 200 through a normal dial-up telephone linkage 205 via a modem 230, a telephone line 235, and a modem 240, though as noted above it is most preferable to implement the communications subsystem using wireless protocols as well known to support data exchanges. A local data structure representative of local AVASpace 210 has been developed at terminal 200 through an AVA server 215 via the communications linkages from server 215, which may have accessed them from network 225 via linkage 220. An AVA client program 245 operates within terminal 200 to control the communication with server 215 to thereby transceive and process (e.g., display) the local AVASpace 210 on terminal 200. Also communicated to network 225 are web page site 250 and web site 255, where remote resources are stored and accessible to computing systems of the present invention. In addition, the system includes one or more additional AVA clients (e.g., AVA device 260), third-party processes 265 (e.g., printing, archiving, and the like), and additional AVA resources 270 also available to the computing systems of the present invention.

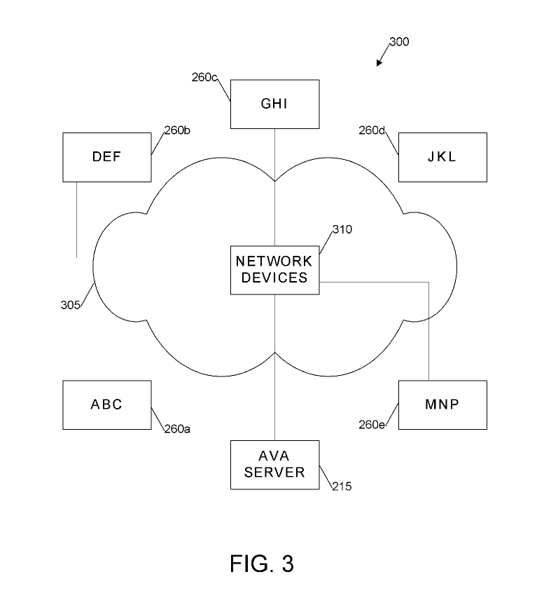

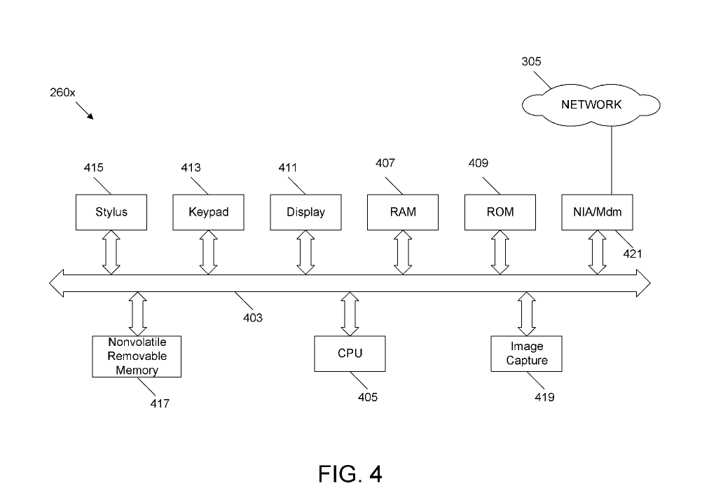

With this setup, the present invention, which will be subsequently described in greater detail with respect to FIGS. 3 and 4, will be carried out using a plurality of AVA clients 245 communicating to one or more AVA servers 215 and one or more other AVA devices 260 and optionally other resources as shown in FIG. 2. As described in more detail below, any particular AVA client 245 connects to a data structure of AVA server 215 using appropriate messaging protocols (and often requires login credentials for access) and thereafter all AVA devices 260 (including terminal 200 supporting AVA client 245) also communicated to the same data structure directly exchange messages with each other through AVA server 215 to control a content of a local AVASpace 210 of each AVA device 260.

A feature of a preferred embodiment of the present invention is support for natural and instant ad hoc collaboration networks that setup simply and exist only as long as desired. A first participant uses an AVA client to create an AVASpace (with any access controls) from desired content and provides the access information to other participants. As these other participants attach to the AVASpace, the content is reproduced in each local AVASpace of each attaching AVA client. Each user participates in the session and as the other participants detach, the content from the AVASpace of the detaching participant is removed from the device supporting the local AVASpace, leaving no presence behind. The first participant may use content from a removable memory system operable with the electronic device supporting the AVA client to also leave no copy of the desired on the electronic device. In some instances, the AVA client is operable from the removable memory system as well. Thus these ad hoc collaboration networks have low resource requirements, are created easily, and may be configured to leave no trace of the clients or of the content on supporting electronic devices as the network is dismantled—a non-persistent network with non-persistent content that enhances data security and ensures that each ad hoc network includes the latest and most current content available to the originator/creator.

FIG. 3 is a generalized schematic of an AVA collaboration system 300 shown in FIG. 2. System 300 includes a plurality of AVA devices 260x (each supporting an AVA client 245 as shown in FIG. 2) exchanging messages (with AVA server 215 and among other AVA devices 260 through AVA server 215) as detailed elsewhere herein through a network 305 including network devices. Each AVA device 260x is communicated to a port of AVA server 215 and initially is able to exchange messages with only AVA server 215. AVA server 215 includes one or more data structures for supporting message exchange between a set of AVA devices 260. An AVA device 260 successfully attaching to one of these data structures thereafter exchanges messages with all other AVA devices attached to the same data structure. AVA server 215 routes messages from one AVA device 215 attached to a data structure to all other AVA devices 260 also attached to the same data structure. Thus server 215 may be supporting multiple sets of AVA devices 260, each participating in an independent message exchange with server 215 routing all messages as appropriate. In the preferred embodiments, the system supports multiple concurrent real-time message exchange from multiple clients to other attached clients. And most preferably, each user may use their client to process any resource in the AVASpace at any time, with the result of each processing reproduced in all-other local AVASpaces of attached AVA clients.

FIG. 4 is a generalized block diagram of a generic computer of system 300 shown in FIG. 3, e.g. AVA client 260x or AVA server 215, includes several functional units connected in parallel to a data communication bus 403, for example of the PCI type. In particular, a Central Processing Unit (CPU) 305, typically comprising a microprocessor, controls the operation of the computer 260x/215, a working memory 407, typically a RAM (Random Access Memory) is directly exploited by the CPU 405 for the execution of programs and for temporary storage of data, and a Read Only Memory (ROM) 409 stores a basic program for the bootstrap of the computer 260x. The computer 260x comprises several peripheral units, connected to the bus 403 by means of respective interfaces. Particularly, the peripheral units that allow the interaction with a human user are provided, such as a display device 411 (for example a CRT, an LCD or a plasma screen—most preferably touch sensitive to respond to a stylus), a keypad 413 and a pointing device 415 (for example a mouse or a trackpoint/trackball, or a stylus interfacing with display 411). The computer 260x/215 also includes peripheral units for local mass-storage of programs (operating system, application programs) and data, such as one or more nonvolatile removable memory structures, globally indicated as 417, and an image capture system 419 (e.g., a CCD camera or other capture system and the like). Other peripheral units may be present, particularly in an implementation for server 215, such as a floppy-disk driver for reading/writing floppy disks, a memory card reader for reading/writing memory cards and the like, hard disk drives, magnetic-optic memory systems, and the like. The computer 260x/215 is further equipped with a Network Interface Adapter (NIA) card 421 for the connection to the data communication network 305 preferably using wireless systems for portable/mobile units; alternatively, the computer 215 may be connected to the data communication network 305 by means of a MODEM or other signal exchange system, wired or wireless. Of course, computer 260x/215 could also be configured according to FIG. 1 as well-known, with FIG. 1 and FIG. 4 describing alternative systems.

Any other computing system 260x/215 in the computer network 300 has a structure generally similar to that depicted in FIG. 4 (or FIG. 1, possibly properly scaled or alternatively configured depending on the machine computing performance, computing tasks, and implementation details).

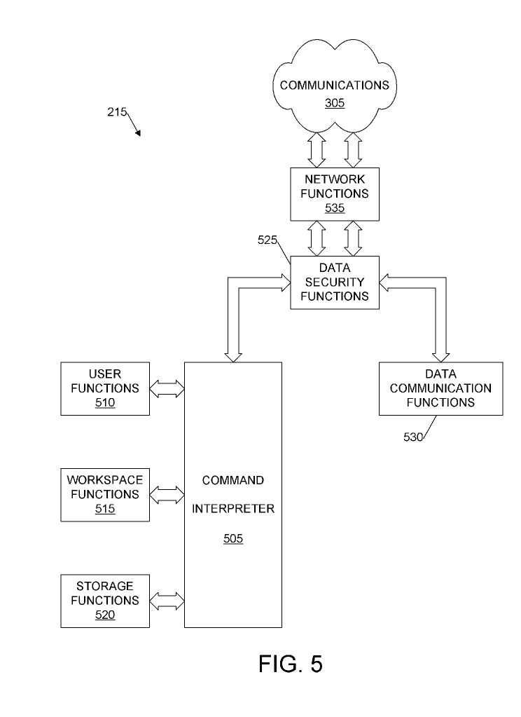

FIG. 5 is a functional block diagram of AVA server 215 shown in FIG. 3. AVA server 215 according to the preferred embodiment is an application written in the C programming language, supported by one or more computing systems described herein, and does not use a graphical user interface. AVA server 215 is command-line based and outputs any information to a log file. Source code and related resources for AVA server 215 are compiled and executable on Windows, Linux and Unix computers, and the like.

AVA server 215 includes a command interpreter 505 coupled to a set of user functions 510, a set of AVASpace functions 515, a set of storage functions 520, and a set of data security functions 525. A set of data communication functions 530 is also coupled to data security functions 525. Data security functions 525 is coupled to send and receive via network 305 through use of a set of network functions 535.

Command interpreter 505 processes buffers of data that have been read from the communications channels and assembles them into correctly formed AVA packets. This includes combining several packets into a single packet in some implementations. The packets are checked that they are well formed and then dispatched according to their operation code.

User functions 510 include those functions related to managing and checking user logins and parameters. This includes functions such as “Request User ID”, “Request User Color”, “User Disconnected” and others.

AVASpace functions 515 encompass those functions for creating and manipulating AVASpaces and their objects (e.g. windows). Example commands include “Create Window”, “Move Window”, “Add Bitmap” and many others.

Storage functions 520 include those functions related to storage and retrieval of AVASpaces. Example commands include “Save AVASpace” and “Restore AVASpace”. Since AVASpaces may be stored on both the server and on the client, these commands work on multiple communications channels.

Data security functions 525 include those functions related to protecting the integrity of both the communications session and the data. This includes functions such as “Verify Password” and the basic data encryption for data packets.

Data communications functions 530 include broadcast functions that handle broadcasting of client data to all other clients connected to an AVASpace. When a client sends a data command to the AVASpace, these functions queue the packet for re-broadcast to all of the connected clients. Since re-broadcast of the packets may send different amounts of data to each client (as their network speeds may be different), care is taken to not duplicate the data or slow the entire re-broadcast to the slowest client.

Network functions 535 include low-level networking routines, including establishing the network connections, detecting when a network connection has been lost, reading and writing data packets, checking for blocked (full) data connections, and the like.

When AVA server 215 starts, it reads any command line arguments and configures one or more communications port that AVA clients will use when communicating with it and through it. Optionally, it creates a new log file for logging errors and information. The type of information that is logged is configurable via the command line, from “errors” to “data flow”.

AVA server 215 includes two roles:

### 1) Respond to requests for information from AVA clients, such as “Client Connects”, “Attach To AVASpace” and “Save AVASpace” commands and messages; and

### 2) Move data from one AVA client to another that are connected to the same AVASpace.

As used herein, the term AVASpace includes two different connotations depending upon whether an AVA server is being discussed or an AVA client is being discussed, as well as encompassing the term “workspace” as used in the incorporated patent applications. In some of the related incorporated patent applications, workspace was used interchangeably with the newer “AVASpace” but not desiring to unnecessarily limit a system useful for entertainment, fun, and the like it is desirable to avoid linking the system to working, business environments. No limitation of the scope is desired to be achieved, but rather a desire to avoid unnecessary narrowness motivates some of this change, at least in part. An AVASpace for an AVA server is a data structure that preferably includes a state machine for managing an attachment state of AVA clients communicated to it through one or more of its communications port. The AVASpace of an AVA server determines which AVA clients are authorized to route messages to other AVA clients attached to the same communications channel. In the preferred embodiment, each AVA client issues messages and receives messages from an AVA server—sometimes those messages are destined for the AVA server, and sometimes to other AVA clients. The destination is determined by a connection status as reflected in this data structure/state machine/server AVASpace. In contrast, each AVA client includes a local AVASpace where one or more resources exist—the reproduction, manipulation, editing, commenting, and the like by one AVA client on a resource within its local AVASpace generates messages reflecting the local processing. These messages are communicated to an AVA server and may, when the client is attached to a data structure that identifies other AVA clients similarly attached, route to these similarly attached AVA clients. In the preferred embodiment, these messages result in duplication of a result of a local processing in all the other AVA clients receiving the messages.

Server 215 opens a socket on the requested port and waits for a connection from an AVA client application 245 executing on AVA device 260. When client 245 connects, server 215 creates an internal “connection” and waits for data to be sent. Initially, server 215 interprets all data received via the protocol (below) until it receives an “Attach To AVASpace” command, in which case that connection is thereafter just used to move data (without interpretation) to other clients 245 also attached to the same AVASpace. Each AVA server 215 may support one or more multiple independent server AVASpaces, permitting multiple sets of multiple AVA devices 260 to exchange messages with each other through AVA server 215.

The Protocol

Data is sent to and from the server and other clients via a byte-stream binary protocol. The protocol of the preferred embodiment includes:

Two Bytes of “start mark”, which are the characters “A” and “P” (for “AVA Protocol”);

Two Bytes of “command size”, with the first byte being the lower 8 bits of the size;

Two Bytes of the command; and

Followed by the command data.

The command data types include:

Sixteen bit integer;

Thirty two bit integer; and

String (proceeded by a sixteen bit count, not null terminated).

Commands are terminated by:

Two bytes of “end mark”, which are the characters “E” and “P” (for “End Protocol”).

Command Interpretation

Command interpretation in the preferred embodiment is similar on an AVA server as it is on AVA clients. Data is read from the clients and assembled into complete commands. Commands are checked for correctness, by checking the start mark, command length and end mark. When, for some reason, the commands are malformed, a command interpreter will move forward in the data received until a correct command is recognized. When a complete command is assembled, a jump table is used to dispatch the command. Individual command functions in turn read and parse the command data from the data buffer that was read.

A special command from an AVA device, “Attach To AVASpace”, interpreted only on an AVA server, moves the data connection to an AVASpace and triggers another mode of operation. This other mode no longer interprets commands in the data received, but instead “broadcasts” them to others that have attached to the AVASpace. In this way, clients are more closely communicating directly with each other, only using the AVA server as a conduit for data transfer. Data transmissions of this preferred embodiment are more secure, as they are not understood by the server.

Commands between server and client(s):

Client Connect;

Attach AVASpace (client to server);

Acknowledge Attach AVASpace (corresponding server to client);

Request List of AVASpaces (client to server);

AVASpace Request Response (corresponding server to client);

Request A Unique User ID (client to server);

User ID Response (corresponding server to client);

Requests A Server Start Time (client to server); and

Server Start Time Response (server send only).

Commands between clients:

Move Window

Resize Window

Draw Window

Create Image Window

Add Bitmap To Window

Add Pixels To Bitmap

Annotation Rectangle

Annotation Note;

Delete All Annotations;

Define User Color;

Instant Message;

Drop Image Into Folder;

Drop Image Onto AVASpace;

Open Folder;

Close Folder;

Create Folder;

Show Image Transfer Progress;

Zoom In On Image;

Zoom Out On Image;

Pan Up On Image;

Pan Down On Image;

Pan Left On Image;

Pan Right On Image;

Minimize Window;

Maximize Window;

Create Audio Window;

Add Audio Data To Window;

Play Audio;

Stop Audio;

Run Animation; and

End Animation.

The protocol is a general purpose protocol and permits expansion/modification to a number and type of commands as product features are created or implemented. These are simply representative commands for a preferred embodiment of the present invention. Other implementation and embodiments of the present invention may include different or additional commands.

Functionality/Interface Elements:

I. Connecting, that includes:
Finding friends (Showing who is currently on; Finding them via search; and Sending invitations to download and join AVA);
Creating a session (“channel”) with friends;
Creating groups;
Creating a session (“channel”) with a group;
Sending invitations (including SMS; and Email); and
Responding to invitations.

II. Exchanging files with friends and groups (during AVA session), including:
Image;
Audio (clips and songs); and
Video (clips).

III. Sending files to friends and groups (not during AVA session), including:
Image;
Audio (clips and songs); and
Video (clips).

IV. Receiving files (both in and out of session), including:
Image;
Audio (clips and songs); and
Video (clips).

V. Forwarding files to other users, including:
Without creating a session.

VI. Switching between files.

VII. Viewing files and playing files.

VIII. Seeing and experiencing what others are viewing and playing (synchronous/concurrent), including:
Watching a user “channel” (including Public channel and Private channel).

IX. Image files, including:
Add comments (e.g., Text comments; Vote; and Emoticons).

X. Audio files, including:
Playing audio;
Pausing and stopping audio;
Fast forward audio (when necessary/desirable);
Rewind audio (provision for limited rewind-like a single 5 second rewind or other period appropriate for implementation);
Go to the beginning of the audio (may be automatically accomplished when you hit stop); and
Add comments (including Text comments; Vote; Emoticons).

XI. Video files (same comments as per audio files), including:
Playing video;
Stopping video;
Fast forward video;
Rewind video;
Go to the beginning of the video;
Add comments (including Text comments; Vote; Emoticons).

XII. Persistence (as appropriate/necessary/desirable), including:
Saving channel contents locally;
Restoring channel contents locally; and
Server saved channel contents—12 hour maximum or other period which in some cases may be practically indefinite.

XIII. Preferences, including:
Saving preferences; and
Restoring preferences.

XIV. Instant messages, including:
Sending;
Receiving; and
Stored instant messages—12 hour maximum or other period which in some cases may be practically indefinite.

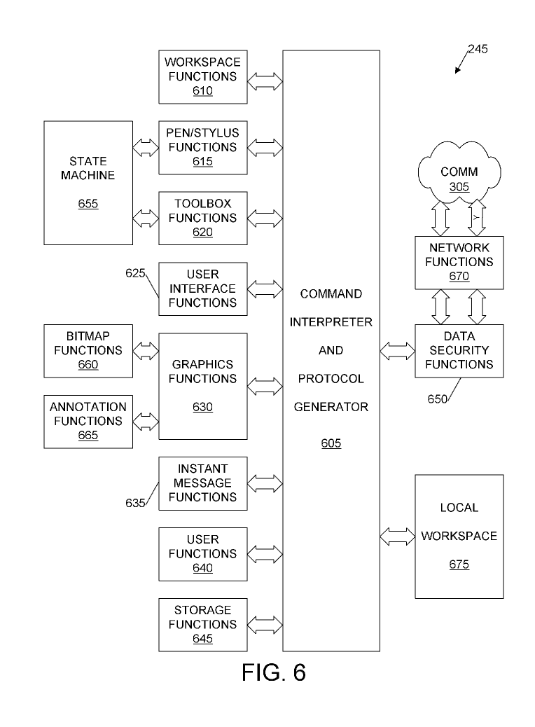

FIG. 6 is a functional block diagram of AVA client 245 shown in FIG. 2. AVA client 245 according to the preferred embodiment includes a command interpreter and protocol generator 605 coupled to a plurality of sets of functions. These sets of functions include: AVASpace functions 610, keypad/pen/stylus functions 615, toolbox functions 620, user interface functions 625, graphics functions 630, instant message functions 635, user functions 640, storage functions 645, and data security functions 650. A state machine 655 is coupled to keypad/pen/stylus functions 615 and to toolbox functions 620. A set of bitmap functions 660 and a set of annotation functions 665 are both coupled to graphics functions 630. Data security functions 650, compatible with data security functions 525, are communicated to network 305 through a set of network functions 670. Interpreter/generator 605 of the preferred embodiment interacts with the plurality of sets of functions described herein to define and manipulate a state of one or more resources made available in a local AVASpace 675. These resources either originate locally or are reproduced from messages received from communications network 305 (as noted above, locally originated resources and processing thereto generate one or more messages to replicate the resources and the results of the local processing in other AVA clients attached to the same data structure of an AVA server).

A preferred embodiment of AVA client 245 includes client software that is written in the C programming language. Much of the software of the preferred embodiment is general purpose and may be used on Palm, PC, Mac, Symbian, Windows Mobile V5, and the like, and other existing and future operating systems. Platform specific routines are used for networking, mouse and pen/stylus input and drawing to the screen.

Client 245 maintains a “display list” of the resources (e.g., images, documents, videos, audio content, instant message sessions, virtual whiteboards, and the like), windows and folders on the display. Commands from the navigation controls (e.g., pen, mouse, scroller wheels, buttons, and the like), as well as those from the network are used to manipulate the display list and draw the objects on the screen or perform other interface functions. Each time an action is initiated on the display, such as moving a window, a command is created and sent to the server for use by all other clients that have attached to the AVASpace. An intent is to keep all clients as closely in sync as possible. Moreover, the network routines work in parallel to the local mouse and pen routines, so that commands from other clients are merged as quickly as possible to keep the display up to date.

Module Breakdown (Some of the Following May be Optional)

Local AVASpace (Distributed Virtual Light Table) Functions 610:

### These routines manage local AVASpace 675, keeping track of the windows that appear on it and their background colors etc.

Keypad/Pen/Stylus Functions 615:

### These routines interpret pen/stylus movements and drive state machine 655 to set the state for drawing, dragging windows, and resizing, among other functions.

State Machine 655 Functions:

### These routines manage state machine 655—keeping track of the current mode of the applications, such as dragging, drawing, and the like.

Annotation Functions 665:

These routines manage a creation and a display of annotations of resources within local AVASpace 675 (e.g., marks on top of the images). There are three types of annotations of the preferred embodiment applicable to an image-type resource—rectangle, freehand, and note. Note annotations display as a small icon and have text contained in them that may be displayed and edited.

Toolbox Functions 620:

These routines handle the display, animation, and selection of tools in a toolbox (a collection of “virtual” tools that interact with the resource(s) of local AVASpace 675. The toolbox “slides out” from an edge of the screen (e.g., the left side) when the user clicks down close to the edge. Selecting a tool updates state machine 655 for the current “mode” of the application.

Graphics Functions 630:

These routines handle all graphics for the application. Most of the functions map onto operating system support functions, such as drawing rectangles, lines, text, and the like. All bitmap functions, except drawing to the screen, such as scaling, are handled internally.

Note that the Palm and the PC have different screen characteristics—the PC being 24 bits deep and the Palm being 16 pixels deep. This has added complication for sending pixels from one type of AVA client to another and may be accommodated by different ways including translation functions in an AVA client or in an AVA server.

Instant Message Functions 635:

Associated with each resource may be one or more instant messages (e.g., a list). These may be entered and sent to all other users that are connected to the particular AVASpace. These routines handle all input and display of the instant messages.

User Interface Functions 625:

These routines handle the creation, display, and updating of any dialog boxes, alerts, and controls. These routines of the preferred embodiment only use the native operating system support for user interface controls, resulting in slightly different looks on the different versions of AVA (for example because the Palm has a small screen and fairly large fonts).

Storage Functions 645:

### These routines handle all storage and retrieval of the AVA sessions.

User Functions 640:

### These routines manage and keep track of the users of AVA—sending and retrieving user information (such as a currently selected color of a user) with all AVA clients and AVA servers.

Command Interpreter and Protocol Generator 605:

These routines interpret and generate packets of information that have been received and will be sent to other AVA clients and AVA servers. The packet protocol is described above in connection with a description of an AVA server as part of FIG. 5.

Data Security Functions 650:

These routines implement any data security aspects of receiving and sending on network 305. These include encryption, CRC validation, and the like. For some applications, these are optional.

Network Functions 670:

These routines connect, read, write and disconnect from the network. They assemble complete commands from data received and buffer up writes for reliable sending on the network.

External File Handling:

These routines handle the import and export of external data resource files—for images/videos these files are stored in standard image formats, such as BMP, JPEG, TIFF, mp3, and AVI for example. In addition, functions in some embodiments exist for handling import/export/editing/annotation of metadata format types including EXIF data and the like that supports timestamps, keywords, and other metadata for example.

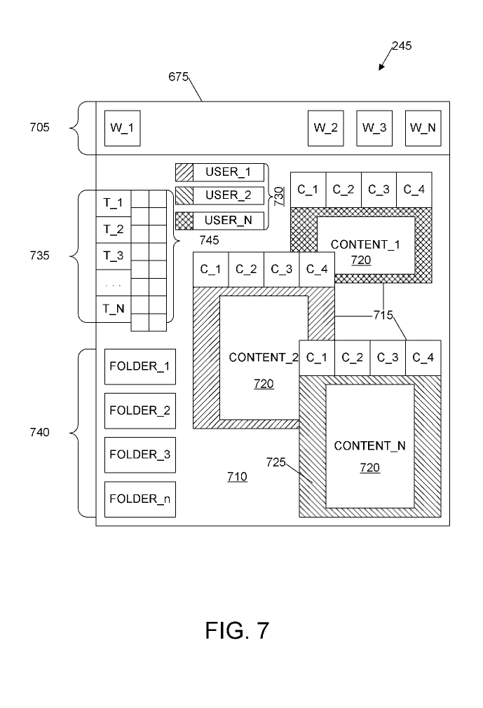

FIG. 7 is a close-up of an AVA client 245 supporting local AVASpace 675. AVASpace 675 includes a window toolbar 705 and a resource area 710. Window toolbar 705 includes a number of toolbar controls W_x, x=1 to N. These are specific to any implementation and may include minimize, maximize, restore, close, and the like.

Resource area 710 is populated with one or more resource windows 715—each resource window having a set of controls (e.g., C_1, C_2, C_3, and C_4) and a resource viewer for supporting a content that is a particular type of a resource 720. For example, resource 720 may be a still image, a video, an animated GIF, a document, an audio file, an instant message, a whiteboard (e.g., a window supporting real-time two way entry of drawing and text). Controls C_x for each resource window 715 are appropriate for the specific type of resource it supports.

Each resource window 715 of the preferred embodiment also includes a user identification system. A border 725 surrounding resource 720 of any given resource window 715 is encoded (e.g., using color or pattern or combination) to indicate which AVA client (and thus which user) is currently processing a particular resource (or which last processed a resource). A color/pattern mapping resource 730 provides a mechanism to identify a border color/pattern and the responsible user. When a user “touches” a particular resource window 715, border 725 is changed in all AVA clients 245 to the color/pattern of the user. Touching includes moving, editing, and annotating, as well as all other supported resource-interfacing/interacting tools and objects. In this way, all users know who is performing a current processing of any particular resource 720 (or resource window 715).

Resource area 710 also supports a toolbar 735 (having a set of tools T_x, x=1 to N), a set of folders 740 for organizing resources out of an active region (one folder is a special folder denominated as “trash”), and a palette 745 for selecting an effect applied to certain ones of the tools (e.g., a color selector for a drawing tool).

In operation, a user processes local AVASpace 675 of AVA client 245 to add one or more resources, modifies one or more resources, annotates one or more resources, sends instant messages about one or more resources, creates content in real-time (such as drawing/typing and the like in the virtual whiteboard shared across all AVA clients), and perform other supported functions. Each AVA client 245 attached to an AVASpace reproduces a layout/arrangement and content 720 of resource windows 715 in the individual local AVASpaces, as close to real-time as network communications 305 permits—not just statically but also dynamically. Dynamic reproduction is when a processing in any one local AVASpace is duplicated/replicated/reformed in all the other attached local AVASpaces in as close to real-time as network communications 305 permits and as close as possible/reasonable given different display attributes (e.g., color depth, screen resolution, and the like). For example, if an annotation is being made, the preferred embodiment exchanges messages/commands among all the several attached local AVASpaces to duplicate the annotation as it is progressing. Border 725 changes to match the color/pattern of the user when the annotation starts and all the users see both who is doing the annotation and the results of the annotation. Reproduction includes wholly replacing a resource in a state with another resource or the same resource in another state. It also includes application of resource processing directives that change the resource from a current state to the desired state to match the state of the resource in the local AVASpace of the originating AVA client, and combinations of the these two types of reproduction.

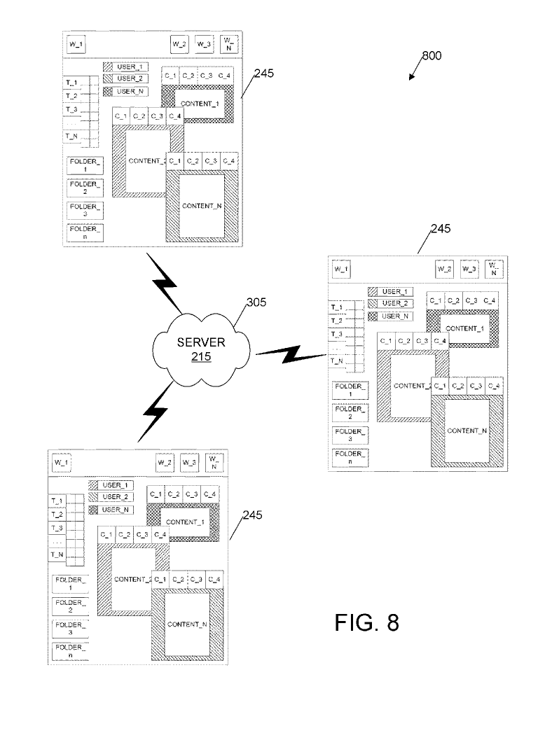

FIG. 8 is a schematic block diagram of a preferred embodiment for an AVA real-time collaboration system 800 including a plurality of portable electronic devices each supporting an AVA client 245 wirelessly communicating with an AVA server 215 through a wireless-supported communications network 305. Each client 245 is synchronized to show the exact same state for each local AVASpace as every other client 245. Any user may “process” any resource, with a result of the processing being reproduced in all other clients.

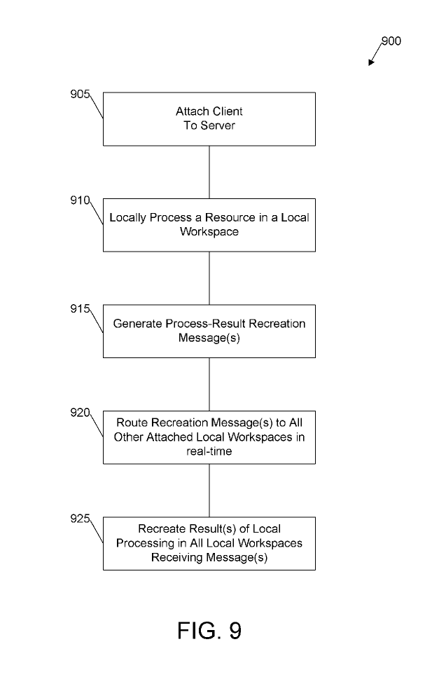

FIG. 9 is a preferred embodiment for an AVASpace recreation process 900 implemented by a system (e.g., system 800 in FIG. 8). Process 900 includes a first block 905 of attaching an AVA client 245 to an AVA server 215 (specifically to a data structure of said server representing an AVASpace communications channel having at least one other AVA client also attached).

Next after block 905, process 900 includes a block 910 for locally processing a resource in a local AVASpace of one of the attached AVA clients.

Next after block 910, process 900 includes a block 915 for generating a process-result recreation message(s). This/these message(s) have the effect, when received in an AVA client, of including instructions to reproduce a state of the local AVASpace of the receiving AVA client to match that of the AVA client generating the message(s).

Next after block 915, process 900 includes a block 920 for routing the process-result recreation message(s) to all other attached local AVASpaces (in real-time).

Next after block 920, process 900 includes a block 925 for recreating the result(s) of the local processing (that initiated the message generation) in all the other attached AVA clients.

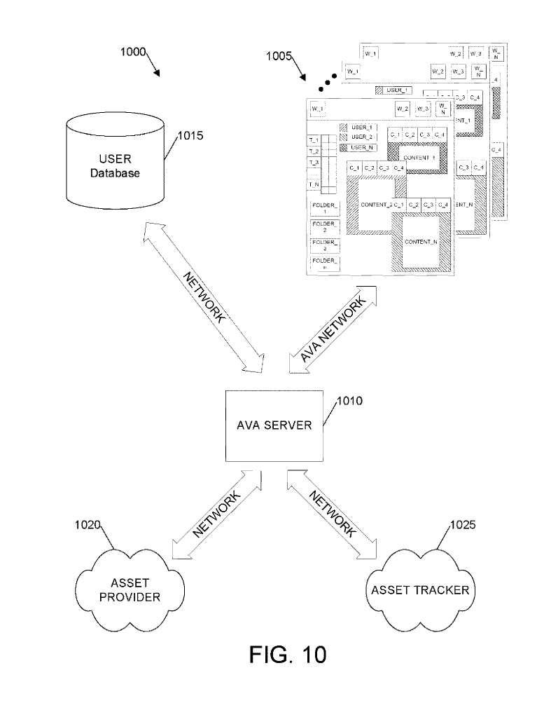

FIG. 10 is a block diagram of an asset tracking system 1000. System 1000 includes a plurality of communication clients (e.g., AVA clients) 1005 coupled over a communications channel (a network connection for example) to one or more communications servers (e.g., an AVA server) 1010. Communications server 1010 is coupled to an asset tracker function 1015. Depending upon an implementation, communications server 1010 is coupled optionally to one or more additional services, such as an asset provider function 1020 (e.g., content database/server including music, videos, documents, advertising, and the like) and a database function 1025 (such as a database for storing data and relationships about users, digital resources, servers and other information). System 1000 operates predominately as a client-server system in which client-to-client communications are mediated/controlled/monitored by communications servers 1010. Resources not created within an AVASpace enter into the AVASpace through a communications client or through a communications server. System 1000 tracks these resources while they exist within the AVASpace, recording desired parameters of the resource(s), its processing(s), and its relationships to users and the associated communications clients. Various of the functions/processes shown in FIG. 10 may be integrated together or otherwise reconfigured appropriate to a particular implementation.

Systems described above included features for collaborative rendering of digital resources. System 1000 monitors and tracks what happens to these digital resources as they are distributed and rendered in the system.

General operational features of communications clients 1005 are described herein, embodiments of the present invention add to and enhance these features by providing a mechanism to track desired processing parameters of one or more digital resources. In some embodiments, all processings of all digital resources are tracked and monitored. In other embodiments, processings of selected resources are monitored, in other embodiments, selected processings are all or selected resources are monitored/reported/tracked. In some embodiments, the information is personally identifiable, and in other embodiments, various aggregate statistics are produced regarding some or all digital resources and some or all processings of these resources.

There are many reasons for monitoring/tracking, and uses of this information when available, that enhance a user experience, and that enhance a provider experience, as well as a content distributor experience. Some or all of these reasons may be present in any particular implementation. The processings that are tracked (including monitoring and reporting) include client-specific processes, server-specific processes, as well as session attributes and other processes that are desirably tracked/monitored/reported appropriate for the particular implementation, embodiment, or application.

For example, client specific tracking of a digital resource may depend upon the specific type of resource and the type of rendering process. As noted above, the digital resource may include an image data file, a video data file, an audio data file, a message (e.g., SMS) data file, a document data file or other type of file. Currently, these different resources each have a different rendering process. The preferred embodiment of the present invention integrates these processes to natively support each data file into a single communication session to combine image, video, audio, messaging, and document information together, seamlessly, without manually starting or referencing additional supporting processes from “outside” the system.

In the case of the renderizers, system 1000 tracks what and when a user, a server, or a provider, does to a digital resource. Examples include playing, launching, starting, stopping, pausing, fast forwarding, rewinding, volume changes, editing (e.g. the data file or attributes of the data file), supplementing, annotating, and the like for the renderizer. Additionally, tracking of “meta” information regarding a specific renderizer includes repositioning, resizing, gaining focus, losing focus, renderizer size, renderizer position, relay of content events (e.g., who (user/group) and when a particular resource is distributed), receipt of content events, identifiers of one or more relay targets, frequency of renderizer events, frequency of renderizer events associated with specific renderized content, count of renderizer events, time of day associated with renderizer events and the like.

System 1000 preferably assigns an identifier to each digital resource and associates this digital resource to each user/group receiving the digital resource in database 1025. There are many different ways to implement assignment/generation of an identifier. In some instances, the identifier is unique (globally or locally) while in other instances, the identifier is reasonably unique given the nature of the implementation. In some cases, the identifier is generated from the resource in a predictable way (e.g., by a hashing function or the like) or other identification creation, assignment, lookup or the like). The preferred embodiment uses an eight digit ID code for the identifier, this ID generated using a hashing system. Additionally, any tracking/monitoring/reporting parameters associated with the user/group and the digital resource are also associated with each other in database 1025. Thus queries against database 1025 produce information about the digital resources and their use/interest, including identification of specific users and way to measure interest within system 1000. This information may be used in many different ways, including providing targeted content (e.g., digital resources tailored for a user/group including specific advertising or other commercial content).

A key aspect of the invention includes resource tracking and user interest measurement for an interactive, collaborative delivery, viewing, moving, sorting, commenting on, editing, listening, playing, and marking of images, video, audio, animation, text, rich media documents, and other objects (including any accompanying metadata), in real time, across computer platforms, networks and operating systems, and telecommunication networks, including mobile platforms and devices, concurrently by an unlimited number of users or groups.

The many-to-many interactivity between mobile users and PC users is an important aspect of the system when tracking the digital resources and the level of interest/importance to various identified users. The preferred systems use a mobile data network and interrupt-driven aspects of the mobile device to attain near-real time interactivity between users.

AVA provides natural, intuitive method of interacting with, and tracking and identifying interested users and levels of interest, visible representations of digital files by providing unrestricted, freeform movement and placement of those representations on a virtual AVASpace displayed on a screen, monitor or any viewing device. The interactivity has significant benefits in sending, receiving, communicating, collaborating, decision making, and commerce initiating, tracking, and game playing using various forms of ordinary and rich content data files.

The AVA system acts as a content communications and tracking vehicle in some preferred embodiments. AVA allows groups of individual user to communicate and collaborate using images, videos, audio, document and other digital files while monitoring and tracking desired features. AVA operates on myriad devices that are connected to networks and/or the Internet. These devices may be computers, wireless devices such as phones and PDA's (personal digital assistants), media players, gaming devices, TV set-top boxes, game consoles (e.g., XBox, PlayStations), digital imaging systems, audio capture systems, and the like. The descriptions herein focus on “PCs” and “mobile devices”—as representative of the wired and wireless classes, respectively, of supporting computing/electronic devices.

A usefulness of some AVA systems derives from a secure communication, delivery/exchange, viewing, and collaboration paradigm with content in free-floating media windows that may be moved/processed interactively anywhere on the AVASpace by any individual connected on a network to that AVASpace while tracking/monitoring the digital resources moving through the system. AVA is used by individuals not connected to the network to collect, view, organize and comment on media files before connecting to the network in some implementations.

The AVA system acts as a Media Delivery Channel and Vessel in some preferred embodiments. AVA redefines user interaction with data as most data is currently confined to non-interactive grids and AVA places data in an appropriate environment that may be free-floating and/or fully interactive.

AVA provides a unique set of tools in a unique collaborative environment which allows groups of individuals to view, and interact with data (changing position of media window on screen, mark-up with drawing tools, zoom in for detailed view, comment upon with text data streams assigned to each window, place content in folders for sorting, link to other files, and create other AVASpaces from files selected from the current AVASpace) while developing data to measure user/group interest levels. For example, users may simultaneously/concurrently watch/listen to video/audio resources, with the users more interested (e.g. full-size screen, increased volume) being identified differently than users less interested (e.g., minimized screen, muted volume). A user may initiate/control playback of such a resource and all AVA clients respond similarly at almost exactly the same time as to be concurrent. Thus, there is no ambiguity as to which video/audio clip/segment is under discussion, and a user controls the playback of the same content in each local AVASpace of attached AVA clients. In some embodiments, friends and other collaborators may be viewed as channels within an AVASpace. One user may activate a resource file (e.g., play a movie or an audio file), the other users in the AVASpace may not participate unless they opt to do so by “tuning” into that user channel. The interactions of a user with a particular user indicate increased interest or decreased interest, and these interactions are tracked to enable determination of an interest quotient (which may indicate more interest or less interest depending upon the specific type of interaction).

AVA provides a real-time, fully interactive collaborative environment for workgroups, play groups, and content providers and the like. The tools for collaboration may in some cases drive and enhance decision-making, worker productivity, entertainment, and commerce. As data in the form of images, video, audio, animation, and rich media documents become ubiquitous in all sectors of business and personal life, methods of sharing and interacting with that data in natural, intuitive ways is a critical element in the development of the Digital Information Age. AVA provides such an interface, while enabling tracking and measurement of true interactivity.

The AVASpace is an area that is a metaphor for a traditional tabletop. Items that may be placed on the AVASpace include images, documents, videos, sound files, animations, digital files, and folders. The items are represented by thumbnails inside objects called “media windows.” Image and document thumbnails may be resized. Folders are shown in a graphical form, with a “representative” image or document embedded. The representative image may be created by and/or chosen by the user.

Media windows are freely moved around on the surface of the AVASpace. Objects may overlap and obscure other objects. Objects are not allowed to be “off” the surface of the AVASpace. Objects may be dragged onto the AVASpace from other “dialog box” windows. These dialog windows are created from a database search (Search Results Window including Web searches) or from opening a folder and dragging and dropping the file or files, onto the AVASpace. Double clicking on folder on the AVASpace opens a Folder Contents Window with the contents of the folder displayed in small thumbnails inside media windows. The local AVASpaces each have a Toolbox attached, for example to the left side, top-side or other location, sometimes in a hide mode or visible depending upon implementation, with tools appropriate for the AVASpace and AVASpace objects. An ad-hoc organization structure is created in the preferred embodiment by creating folders and moving assets to the folder.

Objects on a local AVASpace may be “selected”—their media window “frame” is represented in a contrasting color, most preferably used to identify the user making such a selection. The usual conventions of Shift-select and Cntrl-select will extend the selection to multiple objects. The AVASpace contents, positions and sizes are persistent and saved across login sessions.

Content is sent as individual data files or groups of files from computer to computer, mobile device to mobile device, computer to mobile device, and mobile device to computer in some preferred embodiments. There is no compromise accessing data in the mobile or PC environment. AVA provides a common interface across all platforms. A local AVASpace of an AVA may be used as an always on/always connected interface through which data is sent and received as needed or continuously. Arrival of new data may be signaled visually, by the appearance of a new media window in the local AVASpace, by an instant message, by a sound, vibration or other prompts and the like.

AVA frees data from static grids and introduces a concept of free-floating windows of data which may be concurrently controlled by both local and remote user for the purposes including viewing, listening, markup, collaboration, communication, linking to other data, servers, web servers, and the like.

Media files sent through or resident on the AVA system are linked to other files, high-resolution files and streaming media files resident on any system anywhere in some preferred embodiments. For example, low-resolution thumbnail images may be linked to high-resolution image files that may be resident on any system anywhere. Those linked high-resolution files may be used for such applications as printing and viewing on high resolution and/or large format screens.

Low-resolution images, videos, or short video clips are linked to high resolution and/or full-length images, videos or video streams for viewing or initiating an eCommerce purchase or license to own, view or use the media file in some preferred embodiments. High-resolution image, audio and video files are delivered directly through the AVA system. Collections of audio and video samples are displayed and played through AVA and the user may select the file they want to download or stream to a specified device. AVA is used to play and display full resolution media files such as video, audio, still image, animation, games, and the like.

Additional benefits of preferred embodiments of an AVA system include the following, some, all, or none of which may be included in any particular preferred embodiment:

1. AVA allows active media windows displayed on the AVASpace to be moved freely on the AVASpace. AVA may be used by a single user or, when connected to a network, by two or more users on various devices. When used by concurrent users on various devices AVA generates a synchronous visual display: 1. PCs to PCs in sync; 2. Mobile device to PCs in sync; 3. Mobile device to mobile devices in sync; and 4. PCs to mobile devices in sync.
2. Images may be transferred through the AVA server: 1. Image transfer from PCs to PCs; 2. Image transfer from mobile devices to PCs; 3. Images may be transferred from mobile devices to mobile devices; 4. Images may be transferred from PCs to mobile devices.
3. AVA organizes media windows in folders. The folders are displayed as icons on the local AVASpace and are opened and closed by clicking on an appropriate folder icon. The folders may be moved freely on the local AVASpace. The media windows may be placed in the folders by drag and drop from the AVASpace or from a folder or desktop on a PC or mobile device.

### 4. Folder movement display is in sync on PCs and mobile devices.

### 5. Placing media windows in folders works in sync on all devices.

### 6. Pulling media windows out of folders on placing on AVASpace works in sync on all devices.

### 7. Media windows may be placed in folders in a specific order and that order is retained and is identical on all devices.

### 8. Folders may be sent to an AVA server to create a new AVASpace.

9. Annotation and markup: AVA enables persistent free-form drawing on images, drawings with Bezier curves, squares, rectangles, circles, and other shapes. The lines of the drawings appear on all active screens in the different colors that identify the participant who created the drawing. Each user is assigned a name and color code. The name and color code identifies the actions of the user on the AVASpace in the message stream as color of markings when: a. Drawing on objects; b. As color of object frame when touching an object; c. As color of frame when sending an object to AVASpace. The drawing done by any user is transferred and viewable on the matching file by all connected users from computer to computer, mobile device to mobile device, computer to mobile device, and mobile device to computer.
10. Sharable AVASpaces—collaboration and interaction: Including “chat” (IM) windows connected to each image, which provide a discussion stream between and among the participants. The chat window identifies the participant initiating the chat, displays a file name of the image, document, digital file, or other resource which it is connected to, identifies the participant who originally posted the file to the AVA server, and identifies the comments of any and all participants who are sending messages in the chat. The chat streams could be saved on the server or on local drives to retain all the information, including the image, document, or digital files that were used in the session.|
11. “Approval” process for images, documents or digital files: A dialog box is assigned to each media window, which includes free text, image identification information, and/or a pre-configured form for comments or approval of the content of the window. The information in this box may be transmitted or saved along with, or independent of the data in the window.
12. Content Delivery: Send images, video and other media files to other AVA users in real-time, on computers, mobile devices, game devices, set-top boxes, media players, and other network-connected devices. Secure private network which is established and dissembled in moments. No loss of control, no “temporary” storage of images that is accessible later to enable unauthorized copying. AVA resides and operates on any removable or portable digital storage medium and, at the conclusion of an AVA session, that storage medium may be removed from the device and all trace of the AVA session disappears from the device in some preferred embodiments.

### 13. Simultaneous Interaction: Each AVA user may concurrently move, resize, draw and otherwise manipulate the media on the AVASpace.

14. Viewing with zooming: Media files may be moved, viewed, and zoomed (in/out) for full inspection.
15. Markup: Media files may be drawn on and other AVA users immediately see the result. Drawing lines are displayed in the color assigned to each AVA user.
16. Instant Messaging: Each AVA media file has an instant message session that is stored for later review. The instant message displays information about the data such as the file name and which user originated the file.

### 17. Comments: Annotation notes may be attached to each media window.

### 18. Approval: All drawing, comments, instant messages and other communication consolidated into an approval summary (or approval sheet) that may be saved, printed and distributed.

### 19. Sessions Saved: The local AVASpace, including all the media windows, messaging streams, comments, marks on images, and the like are saved, either on the server or locally.

### 20. Linked to Other Files (High Resolution Resource): Each media file may have a link to a “full quality” version of the file, which is retrieved when and if permissions allow.

### 21. Sorting Function: Media windows are placed for display on the AVASpace and in selected folders in any order and that order can be saved as session information.

### 22. Reporting Function: Information about the session, who participated, which files were shared, when the session took place, and the like is collected, stored, transmitted, and printed.

### 23. Creation of other AVASpaces: Media windows are placed in folders and those folders become the source of a new AVASpace, which may be saved on the server, on a drive or device, or transmitted.

### 24. Distribution of Information: A local AVASpace may, in some cases, be used as a vessel to distribute content by linking to a server or through transmission or direct transfer from a device or drive.

### 25. Storage of Information: A local AVASpace is used in some cases as a vessel to store data.

### 26. Vessel of Information: A local AVASpace is used to view and/or listen to data displayed in the media windows.

27. Collaborative Environment: The AVA system provides interactive tools, available to all users, concurrent and non-concurrent, which allows groups of users to create, transmit, view, share, interact with, comment upon, sort, and otherwise collaborate using data.

### 28. Communication Environment: AVA operates across all computer devices, operating systems and communication networks and thus provides an easy “universal translator/communicator” of resources.

29. Information Interface: The interface is essentially the same on all devices, as close as possible. Allows natural, intuitive viewing, sorting, interaction with data. AVA provides a natural, intuitive user interface, which is free floating, not bound by grids.
30. Commerce: Instant Messaging/other eCommerce mechanism (e.g. data-entry forms) includes facilities for supporting an order submission/processing function. An IM message stream is attached to each media window. Each message triggers an event on the server that activates a sequence of commands initiating a transaction.
31. Click on Resource Bar includes an order request/submission mechanism—link: Clicking on an appropriate place on the border around a media window triggers an event on the server that activates a sequence of commands initiating a transaction, like an online purchase of something depicted in the media window for example.
32. Folder is an ordering mechanism: Clicking on an appropriate place on a folder triggers an event on the server that activates a sequence of commands initiating a transaction.
33. Advertisements are communicated in an AVA vessel with links attached: Media windows and/or folders contain advertising content which is linked to a transaction engine or other content.
34. Decision-making tool: The collaboration environment of the AVA system and the reporting functions facilitate making and recording the collaborative decision-making process to help initiate an appropriate action.
35. Display offers choices: The local AVASpace and folder interface offers an intuitive, drag and drop method of separating and sorting data.
36. Markup offers commentary: The drawing mark-up tools provide a visual form of collaboration with the content.
37. Instant Messages offer commentary: The shared instant message stream allows relevant information to be attached to specific data.
38. Instant Messages offer decision making record: The shared instant message stream records all the comments relating to a specific data file.
39. Entire contents of session, files, and comments are saved for future reference: All data files, media windows, message streams, transactions, image mark-up, annotations, AVASpaces, and folders are retained. Individual medium/media may be saved or “exported”—for example “Save As” features.
40. Some example applications of the usefulness of the AVA platform:
40a. ADVERTISING AGENCY: An advertising agency uses AVA to make selections of images, video, and audio for an ad campaign. Since the people that need to make the selections are typically located in disparate locations, some use the mobile version of AVA in conjunction with their counterparts in offices, using the desktop PC version of AVA to hold a real-time, interactive, virtual meeting during which the participants distribute, view, share, move, and expand the media windows to illustrate which image they are discussing, mark images for editing, place selections in approval and rejection folders and send instant messages noting specific information they wish to associate with the data displayed in a given media window, all driving the decision-making process to a conclusion.
40b. PROFESSIONAL PHOTOGRAPHER: A professional photographer uses AVA to show potential buyers her images, without losing control over the images. She creates a local AVASpace with the images, including comments, pricing and other information and then invites customers to connect to view the images and presents them dynamically by dragging them onto the AVASpace and opening them to full screen size for examination. The customer reacts in real-time by choosing an image and pulls that onto the local AVASpace, viewing it and placing it in a folder representing his “picks” or “rejects.” The customer is able to draw a shape on an image representing a particular crop of element that is of interest. An instant message triggers a purchase agreement for an image. A commercially appropriate file is linked to the display file and delivered electronically or in print to the customer to fulfill the order.
40c. PROPERTY MANAGEMENT: A property management firm uses AVA to work with their maintenance department to visually inspect property problems and maintenance issues. The maintenance crew sends images from their mobile devices, highlighting the problem areas. Management is able to review the images in real-time with the crew to expedite the decision-making process.
40d. FORENSICS: Law enforcement crime scene investigators in the field use AVA to transmit, share, and discuss photographs or videos of evidence with experts in specific areas of expertise. Images of possible suspects are sent to field officers, utilizing an AVA folder, and those images are shown on the screens of mobile devices to potential witnesses. When a suspect is identified, a witness may use a stylus to sign their initials on the image of the suspect. This signed image is instantly viewable to anyone connected to that AVASpace so other members of the crime investigation team know immediately that: 1) a suspect had been identified; and 2) what that suspect looks like.
40e. GAME DEVELOPMENT: AVA is used in electronic games in which the players create a set of visual elements for the game and then use the various tools such as free movement on the AVASpace, mark-up and zoom, to play a game. This game may have components shareable/accessible by all participants.
40f. MEDICAL: Medical expertise is distributed around the world with some geographic areas having little knowledge and some a plethora. AVA is used to transmit, share, and comment on medical images, such as X-rays, from a field hospital in a remote, low expertise part of the world, to a medical center in a major, high expertise city like Boston. In emergency situations, images of injured accident victims are relayed and discussed from the field for on-the-scene diagnosis and treatment.
40g. AUDIO or VIDEO ENTERTAINMENT: A group of people all simultaneously listen to audio files or watch videos and share control of the media by which any of them start, stop, fast forward or reverse the audio or video to discuss, review or simply repeat sections for listening or viewing as if they were in the same room sharing the experience together.
40h. RETAIL SALES: Images representing items for sale are displayed in media windows and two or more people sort through them as if the items were displayed on a table. Each participant places the items they desire to buy in their own personal folder and the contents of the folder trigger an eCommerce buying transaction.
40i. WHOLESALE SALES: A sales rep shows products to a group of customers to gage their interest in new products. Each customer marks with their unique color on each item they approved.
40j. MEETING BOARD: Business of all kinds use a pure color media window as a virtual “whiteboard” upon which participants draw, using their unique color codes, to describe workflows, mathematical formulas, organization charts, product designs, and the like.
40k. MEDIA-CENTRIC ORGANIZATION: In situations where there is a constant flow of information between individuals and groups, an AVASpace is open at all times on the desktop allowing the local user to simply drag and drop media files for instant distribution to other always-on AVA users. Conversely, the open AVASpace provides an always-on, media-receiving and collaboration portal.

Other applications and implementations are well within the scope of the present invention. A reference—“GOING VISUAL, Using images to enhance productivity, decision making and profits,” by Alexis Gerard and Bob Goldstein. Published in 2005 by John Wiley & Sons. ISBN 0-471-71025-3, is hereby expressly incorporated by reference in its entirety for all purposes will aid in further understanding of some of the conclusions and usefulness of the preferred embodiments of the present invention.

In the preceding discussion, certain ones of the embodiments of the present invention have included a discussion of reproducing a media resource across each of a set of messaging clients. Other embodiments of the present invention include substantial synchronization of a rendering of a media resource across all of the AVA clients in an AVASpace, responsive to one or more collaboration messages that may be received from any AVA client (and in some cases received at any time including when another AVA client is issuing its own collaboration message).

In these other embodiments, some key elements include true multi-way, real-time (substantially) renderings of the media resource across all the clients. Some embodiments provide for the rendering controls to be actively distributed (for example, one client may initiate the rendering and another client may stop the rendering, or for more complex controls, any client may start, stop, pause, fast forward, and/or fast rewind a rendering of a media resource, while in other implementations some or all of the controls are limited to some participants, and provision is made in some cases for dynamically assigning “control” rights/permissions to specific users or classes of users. In still other instances, it is provided for the collaboration messages to synchronize a desired reference of the media resource to all of the clients so the nearly identical rendering of the resource occurs at all connected clients. A preferred embodiment of the present invention permits any user to control rendering of the media resource on all AVA clients in substantial synchronization (synchronization that is in unison but for minor communications delays of the communications systems). As noted above, any user may start, stop, rewind, fast forward or operate any other rendering control appropriate for the media, including operating such a rendering control for those renderings initiated or operated by one or more other users.

Herein, when discussing a rendering of a media resource, this concept is considered in the broadest sense. Often, rendering is taken to be applicable to image resources in which a data file (still (e.g., jpeg, gif, or the like) or streaming format (mpeg, avi, or the like) is processed to produce a particular image or image sequence. A rendering system receives the image resource and, based upon the format of the media resource, generates the particular image on an output system (display, printer, or the like). For other media resources, rendering is also used to convert a digital format into a perceptible representation. A media resource includes a document file (word processing, spreadsheet, presentation, and the like) in which a rendering produces the document in a human-readable format. A media resource includes an audio file format (MP-3 and the like) in which a rendering produces the audio file format human-hearing format. The conversion of a machine-readable format to a human-perceivable format encompasses rendering, the specifics of any rendering dependent upon the type of media resource and the desired sense to be used for perceiving the converted format.

When implementing synchronization embodiments as described herein, AVA clients exchange one or more collaboration messages (directly with one another or indirectly through an AVA server or other intermediary system) to synchronize the rendering(s), and specifically to synchronize one or more renderings to desired reference points of the media resource. These collaboration messages effectuate the delivery/exchange, synchronization, and response of the rendering of the media resource to the distributed rendering controls so one operator may unambiguously present the same specific rendering of the media resource on all connected AVA clients. In the preferred embodiment, these controls are available to all users at all times permitting true unrestricted multi-way, real-time, unambiguous collaboration of one or more media resources, though other configurations are noted above.

The system above has been described in the preferred embodiment including an AVA server and a plurality of AVA clients. In alternate preferred embodiments, the AVA clients communicate via a peer-to-peer communications system in addition to or in lieu of Server/Client communications. Additionally, in some embodiments there is value in a system including a single AVA client communicated to an AVA server.

The system, method, computer program product, and propagated signal described in this application may, of course, be embodied in hardware; e.g., within or coupled to a Central Processing Unit (“CPU”), microprocessor, microcontroller, System on Chip (“SOC”), or any other programmable device. Additionally, the system, method, computer program product, and propagated signal may be embodied in software (e.g., computer readable code, program code, instructions and/or data disposed in any form, such as source, object or machine language) disposed, for example, in a computer usable (e.g., readable) medium configured to store the software. Such software enables the function, fabrication, modeling, simulation, description and/or testing of the apparatus and processes described herein. For example, this can be accomplished through the use of general programming languages (e.g., C, C++), GDSII databases, hardware description languages (HDL) including Verilog HDL, VHDL, AHDL (Altera HDL) and so on, or other available programs, databases, nanoprocessing, and/or circuit (i.e., schematic) capture tools. Such software can be disposed in any known computer usable medium including semiconductor, magnetic disk, optical disc (e.g., CD-ROM, DVD-ROM, etc.) and as a computer data signal embodied in a computer usable (e.g., readable) transmission medium (e.g., carrier wave or any other medium including digital, optical, or analog-based medium). As such, the software can be transmitted over communication networks including the Internet and intranets. A system, method, computer program product, and propagated signal embodied in software may be included in a semiconductor intellectual property core (e.g., embodied in HDL) and transformed to hardware in the production of integrated circuits. Additionally, a system, method, computer program product, and propagated signal as described herein may be embodied as a combination of hardware and software.

One of the preferred implementations of the present invention is as a routine in an operating system made up of programming steps or instructions resident in a memory of a computing system as well known, during computer operations. Until required by the computer system, the program instructions may be stored in another readable medium, e.g. in a disk drive, or in a removable memory, such as an optical disk for use in a CD ROM computer input or in a floppy disk for use in a floppy disk drive computer input. Further, the program instructions may be stored in the memory of another computer prior to use in the system of the present invention and transmitted over a LAN or a WAN, such as the Internet, when required by the user of the present invention. One skilled in the art should appreciate that the processes controlling the present invention are capable of being distributed in the form of computer readable media in a variety of forms.

Any suitable programming language can be used to implement the routines of the present invention including C, C++, Java, assembly language, etc. Different programming techniques can be employed such as procedural or object oriented. The routines can execute on a single processing device or multiple processors. Although the steps, operations or computations may be presented in a specific order, this order may be changed in different embodiments. In some embodiments, multiple steps shown as sequential in this specification can be performed at the same time. The sequence of operations described herein can be interrupted, suspended, or otherwise controlled by another process, such as an operating system, kernel, and the like. The routines can operate in an operating system environment or as stand-alone routines occupying all, or a substantial part, of the system processing.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

What is claimed as new and desired to be protected by Letters Patent of the United States is:

1. A system, comprising:
an electronic resource having an associated identifier;
a plurality of communication clients, inter-communicated by a network, for initiating a transfer of said electronic resource from one of said plurality of communication clients to one or more other ones of said plurality of communication clients; and
an asset tracker, coupled to said network, for communicating with a data file to link said associated identifier with each communication client receiving said electronic resource.

2. The system of claim 1 wherein said one or more other ones of said plurality of communication clients are a first set of communication clients further comprising a second set of communication clients including one or more communication clients of said plurality of communication clients wherein said electronic resource is transferred from one of said communication clients of said first set to one or more of said communication clients of said second set.

3. The system of claim 1 further comprising each said communication client of said plurality of communication clients including a process for rendering said electronic resource to produce an associated process parameter wherein said asset tracker additionally links said associated identifier with each communication client rendering said electronic resource along with said associated process parameter.

4. The system of claim 3 wherein said electronic resource is a digital data structure representative of an image when opened in an image viewer included with each of said plurality of communication clients and wherein said associated process parameter includes at least one member of the group consisting of one or more of repositioning said image, resizing said image, annotating said image, modifying a resolution of said image, editing said image, editing an attribute of said image, and combinations thereof.

5. The system of claim 4 wherein at least one of said clients is supported by a portable electronic device.

6. The system of claim 3 wherein said electronic resource is a digital data structure representative of a sequence of sounds when opened in an audio process included with each of said plurality of communication clients and wherein said associated process parameter includes at least one member of the group consisting of one or more of annotating said sequence of sounds, editing said sequence of sounds, editing an attribute of said sequence of sounds, initiating said sequence, suspending said sequence, stopping said sequence, enhanced navigation including fast forward and fast rewind of said sequence, and combinations thereof.

7. The system of claim 3 wherein said electronic resource is a digital data structure representative of a document when opened in a viewer included with each of said plurality of communication clients and wherein said associated process parameter includes at least one member of the group consisting of one or more of repositioning said document, resizing said document, annotating said document, modifying a resolution of said document, editing said document, editing an attribute of said document, and combinations thereof.

8. The system of claim 3 wherein said electronic resource is a digital data structure representative of a sequence of images and synchronized audio content when opened in a video process included with each of said plurality of communication clients and wherein said associated process parameter includes at least one member of the group consisting of one or more of annotating said sequence of images, annotating said synchronized audio content, editing said sequence of images, editing said synchronized audio content, editing an attribute of said sequence of images, editing an attribute of said synchronized audio, initiating said sequence, suspending said sequence, stopping said sequence, enhanced navigation including fast forward and fast rewind of said sequence, and combinations thereof.

9. The system of claim 3 wherein said associated process parameter includes meta-events associated with said rendering including at least one member of the group consisting of one or more of renderizer size, renderizer resizing, renderizer focus gain, renderizer focus loss, renderizer repositioning, renderizer position, relay of content events, receipt of content events, identifiers of one or more relay targets, frequency of renderizer events, frequency of renderizer events associated with specific renderized content, count of renderizer events, time of day associated with renderizer events, and combinations thereof.

10. A method, the method comprising:
a) receiving an electronic resource at a communication client over a network, said electronic resource including an associated identifier; and
b) linking said associated identifier to said communication client in a database structure; and
c) monitoring rendering related processes of said electronic resource by said communications client to generate a set of associated process parameters; and
d) linking said set of associated process parameters to said associated identifier and to said communication client in said database structure.

11. The method of claim 10 wherein said one or more other ones of said plurality of communication clients are a first set of communication clients further comprising a second set of communication clients including one or more communication clients of said plurality of communication clients further comprising transferring, from one of said communication clients of said first set to one or more of said communication clients of said second set, said electronic resource wherein said transfer is included as an associated process parameter of said set of associated process parameters.

12. The method of claim 10 wherein said electronic resource is a digital data structure representative of an image when opened in an image viewer included with each of said plurality of communication clients and wherein said associated process parameter includes at least one member of the group consisting of one or more of repositioning said image, resizing said image, annotating said image, modifying a resolution of said image, editing said image, editing an attribute of said image, and combinations thereof.

13. The method of claim 12 wherein at least one of said clients is supported by a portable electronic device.

14. The method of claim 10 wherein said electronic resource is a digital data structure representative of a sequence of sounds when opened in an audio process included with each of said plurality of communication clients and wherein said associated process parameter includes at least one member of the group consisting of one or more of annotating said sequence of sounds, editing said sequence of sounds, editing an attribute of said sequence of sounds, initiating said sequence, suspending said sequence, stopping said sequence, enhanced navigation including fast forward and fast rewind of said sequence, and combinations thereof.

15. The method of claim 10 wherein said electronic resource is a digital data structure representative of a document when opened in a viewer included with each of said plurality of communication clients and wherein said associated process parameter includes at least one member of the group consisting of one or more of repositioning said document, resizing said document, annotating said document, modifying a resolution of said document, editing said document, editing an attribute of said document, and combinations thereof.

16. The method of claim 10 wherein said electronic resource is a digital data structure representative of a sequence of images and synchronized audio content when opened in a video process included with each of said plurality of communication clients and wherein said associated process parameter includes at least one member of the group consisting of one or more of annotating said sequence of images, annotating said synchronized audio content, editing said sequence of images, editing said synchronized audio content, editing an attribute of said sequence of images, editing an attribute of said synchronized audio, initiating said sequence, suspending said sequence, stopping said sequence, enhanced navigation including fast forward and fast rewind of said sequence, and combinations thereof.

17. The method of claim 10 wherein said associated process parameter includes meta-events associated with said rendering including at least one member of the group consisting of one or more of renderizer size, renderizer resizing, renderizer focus gain, renderizer focus loss, renderizer repositioning, renderizer position, relay of content events, receipt of content events, identifiers of one or more relay targets, frequency of renderizer events, frequency of renderizer events associated with specific renderized content, count of renderizer events, time of day associated with renderizer events, and combinations thereof.

18. A computer program product comprising a computer readable medium carrying program instructions for operating a system when executed using a computing system, the executed program instructions executing a method, the method comprising:
a) receiving an electronic resource at a communication client over a network, said electronic resource including an associated identifier; and
b) linking said associated identifier to said communication client in a database structure; and
c) monitoring rendering related processes of said electronic resource by said communications client to generate a set of associated process parameters; and
d) linking said set of associated process parameters to said associated identifier and to said communication client in said database structure.

19. The computer program product of claim 18 wherein said one or more other ones of said plurality of communication clients are a first set of communication clients further comprising a second set of communication clients including one or more communication clients of said plurality of communication clients further comprising transferring, from one of said communication clients of said first set to one or more of said communication clients of said second set, said electronic resource wherein said transfer is included as an associated process parameter of said set of associated process parameters.

20. The computer program product of claim 18 wherein said electronic resource is a digital data structure representative of an image when opened in an image viewer included with each of said plurality of communication clients and wherein said associated process parameter includes at least one member of the group consisting of one or more of repositioning said image, resizing said image, annotating said image, modifying a resolution of said image, editing said image, editing an attribute of said image, and combinations thereof.

21. The computer program product of claim 20 wherein at least one of said clients is supported by a portable electronic device.

22. The computer program product of claim 18 wherein said electronic resource is a digital data structure representative of a sequence of sounds when opened in an audio process included with each of said plurality of communication clients and wherein said associated process parameter includes at least one member of the group consisting of one or more of annotating said sequence of sounds, editing said sequence of sounds, editing an attribute of said sequence of sounds, initiating said sequence, suspending said sequence, stopping said sequence, enhanced navigation including fast forward and fast rewind of said sequence, and combinations thereof.

23. The computer program product of claim 18 wherein said electronic resource is a digital data structure representative of a document when opened in a viewer included with each of said plurality of communication clients and wherein said associated process parameter includes at least one member of the group consisting of one or more of repositioning said document, resizing said document, annotating said document, modifying a resolution of said document, editing said document, editing an attribute of said document, and combinations thereof.

24. The computer program product of claim 18 wherein said electronic resource is a digital data structure representative of a sequence of images and synchronized audio content when opened in a video process included with each of said plurality of communication clients and wherein said associated process parameter includes at least one member of the group consisting of one or more of annotating said sequence of images, annotating said synchronized audio content, editing said sequence of images, editing said synchronized audio content, editing an attribute of said sequence of images, editing an attribute of said synchronized audio, initiating said sequence, suspending said sequence, stopping said sequence, enhanced navigation including fast forward and fast rewind of said sequence, and combinations thereof.

25. The computer program product of claim 18 wherein said associated process parameter includes meta-events associated with said rendering including at least one member of the group consisting of one or more of renderizer size, renderizer resizing, renderizer focus gain, renderizer focus loss, renderizer repositioning, renderizer position, relay of content events, receipt of content events, identifiers of one or more relay targets, frequency of renderizer events, frequency of renderizer events associated with specific renderized content, count of renderizer events, time of day associated with renderizer events, and combinations thereof.
